(19) United States
(12) Patent Application Publication
(10) Pub. No.: US 2010/0224070 A1
(43) Pub. Date: Sep. 9, 2010

(54) Shipboard Vessel Having a Vertically Aligned Scrubber and Process Component

(76) Inventors: Ronald G. Patterson, San Diego, CA (US); Andrew J. Olds, San Diego, CA (US)

Correspondence Address: Delaney IP, P.O. Box 9542, Rancho Santa Fe, CA, 92067, US

(21) Appl. No.: 12/398,989

(22) Filed: Mar. 5, 2009

(51) Int. Cl. B01D 53/18; B01D 19/00; B01D 53/50; B01D 53/14; C02F 1/72

(52) U.S. Cl. 96/181; 96/235; 96/234

(57) ABSTRACT

The vessel apparatus processes exhaust gases and effluent seawater on a ship. Structurally, the vessel apparatus includes a vertically oriented vessel. Further, a scrubber is positioned within the vessel to remove pollutants from the exhaust gases with seawater. Also, an effluent seawater processing component is positioned in the vessel above the scrubber. Between the processing component and the scrubber is a liquid barrier that prevents effluent seawater from entering the top of the scrubber while allowing exhaust gases to pass from the scrubber to the top of the vessel. For operation of the apparatus, effluent seawater resulting from the scrubbing process is recirculated from below the scrubber to a location in the vessel above the processing component. As a result, the effluent seawater may be processed above the scrubber.

### CROSS-REFERENCE TO RELATED APPLICATIONS

The present application is related to the co-pending application entitled “Caustic-Assisted Seawater Scrubber System”, application Ser. No. 12/398,947, filed on Mar. 5, 2009 and incorporated herein by reference in its entirety.

### FIELD OF THE INVENTION

The present invention pertains generally to a vessel for processing fluid streams on a ship to eliminate pollutants. More particularly, the present invention pertains to a vertically oriented vessel formed in a ship that holds a scrubber at a position beneath a component for treating effluent seawater. The present invention is particularly, but not exclusively, useful as a vessel apparatus that includes a first stage seawater scrubber and a second stage effluent seawater processing component, such as a degasifier, an oxidizer, a caustic addition stage, or a separator to provide effluent seawater that is environmentally safe for discharge into the sea.

### BACKGROUND OF THE INVENTION

As is well known, the combustion of hydrocarbon-containing fuels, such as diesel, results in exhaust gases containing sulfur compounds including sulfur dioxide. Further, the presence of sulfur dioxide in the atmosphere has been linked to the formation of acid rain. Due to the ecological damage resulting from acid rain, the United States Environmental Protection Agency has set standards for land-based power plants to prevent the emission of sulfur dioxide.

While land-based plants have taken a variety of methods to reduce or eliminate the emission of sulfur dioxide, many of these are inappropriate for shipboard plants. In fact, the land-based methods are often inapplicable to shipboard plants.

In light of the above, it is an object of the present invention to provide a vertically oriented shipboard vessel holding a first stage scrubber and a second stage effluent seawater process component. It is another object of the present invention to provide a ship forming a vessel having a degasifier positioned above a seawater scrubber to degasify effluent seawater from the scrubber to reduce the amount of caustic necessary to raise the pH of the seawater to a level acceptable for discharge into the sea. It is another object of the present invention to provide for return of the gases removed by the degasifier to the bottom end of the scrubber. It is another object of the present invention to provide a vessel that utilizes caustic to reduce the sulfur dioxide load on the seawater solvent for discharge into the sea. Still another object of the present invention is to provide a sulfur dioxide scrubbing vessel that provides for the removal of oils and ash or other particulate from the effluent seawater for discharge into the sea. Still another object of the present invention is provide a vessel that houses an oxidizer for processing effluent seawater to reduce its chemical oxygen demand level. Yet another object of the present invention is to provide a shipboard vessel for removing sulfur dioxide from shipboard exhaust gases with seawater and for processing the effluent seawater which is easy to use, relatively simple to implement, and comparatively cost effective.

### SUMMARY OF THE INVENTION

The present invention is directed to a vessel apparatus for processing exhaust gases created by the powerplant on a ship. Importantly, the vessel apparatus includes a vertically oriented vessel formed and mounted in the ship. Structurally, the vessel defines a vertical axis and includes a wall that bounds a chamber which extends along the axis.

Positioned within the chamber is a scrubber, which may be designed to optimally remove sulfur dioxide from exhaust gases in certain embodiments. Accordingly, an exhaust port may be formed in the vessel below the scrubber for introducing the exhaust gases into the scrubber. Further, the scrubber may use seawater as a solvent to remove sulfur dioxide from the exhaust gases. For the use of solvent seawater, a seawater inlet may be formed in the vessel above the scrubber to feed the seawater into the scrubber. Also, an effluent outlet may be formed in the vessel below the scrubber to remove the effluent seawater downstream from the scrubbing process.

For the vessel apparatus, a component for processing the effluent seawater is also positioned within the vessel. Specifically, the processing component is positioned within the vessel above the scrubber. In order to allow this set up, a gas-permeable liquid barrier is mounted within the vessel between the scrubber and the processing component. As a liquid barrier, it allows the exhaust gases to pass from the scrubber to the top of the vessel while prohibiting passage of the effluent seawater into the scrubber.

Further, a recirculation port is formed in the vessel above the processing component, and is placed in fluid communication with the effluent outlet via a recirculation conduit. As a result, the effluent seawater may be delivered from below the scrubber to above the processing component for treatment. Also, a discharge port may be formed in the vessel between the processing component and the liquid barrier for discharging treated effluent seawater from the vessel.

In certain embodiments, the processing component may be a degasifier. After the scrubbing process, the effluent seawater may contain dissolved carbon dioxide. Because dissolved carbon dioxide is acidic, the degasifier provides for the removal of the carbon dioxide from the effluent seawater. As a result, the amount of caustic needed for neutralization of the seawater at a later stage is reduced. Also, the gases removed from the effluent seawater by the degasifier may include sulfur dioxide. Therefore, the vessel may include a conduit to feed the removed gases from the degasifier back into the bottom of the scrubber.

Also, in certain other embodiments, the processing component may be an oxidizer for reducing the chemical oxygen demand of the effluent seawater. Specifically, the scrubbing process converts sulfur dioxide (SO₂) to sulfur trioxide (SO₃). However, the fully oxidized form of sulfur is sulfur oxide (SO₄). Therefore, the effluent seawater has a demand for extra oxygen, i.e., its chemical oxygen demand. By using a permanganate bed, oxidizing fluids, or other oxidizing media, the SO₃ converts to SO₄ and the demand is reduced or eliminated.

Further, the processing component may be a separator, such as a hydroclone centrifugal separator. Such a separator is able to remove particulate, such as ash, and oils from the effluent seawater.

In yet other embodiments, the processing component may be a caustic addition stage. For such a stage, caustic chemicals are introduced to neutralize the acidic effluent seawater after the scrubbing process. As the effluent seawater exits the scrubber, it is extremely acidic due to the conversion of the sulfur dioxide to sulfite and sulfur trioxide. In order to raise the pH of the effluent seawater to an acceptable level, such as a pH of about 6.5, an appropriate amount of caustic may be added to it. Then the effluent seawater may be discharged into the sea. As a result, the ship is able to use the plentiful supply of seawater without requiring storage of the solvent seawater or storage of the effluent seawater. Further, in the present system, a relatively low amount of seawater, and a relatively low volumetric flow rate of seawater through the scrubber (such as less than 7500 gallons/minute, less than 5000 gal/min or even less than 2500 gal/min for 97% removal of sulfur dioxide from the exhaust gases, and about 1800 gal/min for 75% removal) is needed for effective removal of sulfur dioxide from the exhaust gases.

### BRIEF DESCRIPTION OF THE DRAWING

The novel features of this invention, as well as the invention itself, both as to its structure and its operation, will be best understood from the accompanying Figure, taken in conjunction with the accompanying description, in which similar reference characters refer to similar parts, and in which:

FIG. 1 is a perspective view of a ship having a vessel apparatus in accordance with an embodiment of the present invention;

FIG. 2 is a cross sectional view of the vessel apparatus of FIG. 1;

FIG. 3 is a cross sectional view of an alternative vessel apparatus having a plurality of process components within the vessel above the scrubber; and

FIG. 4 is a plan view of a caustic-assisted seawater scrubber system for removing sulfur dioxide from shipboard diesel exhaust gases.

### DESCRIPTION OF THE PREFERRED EMBODIMENTS

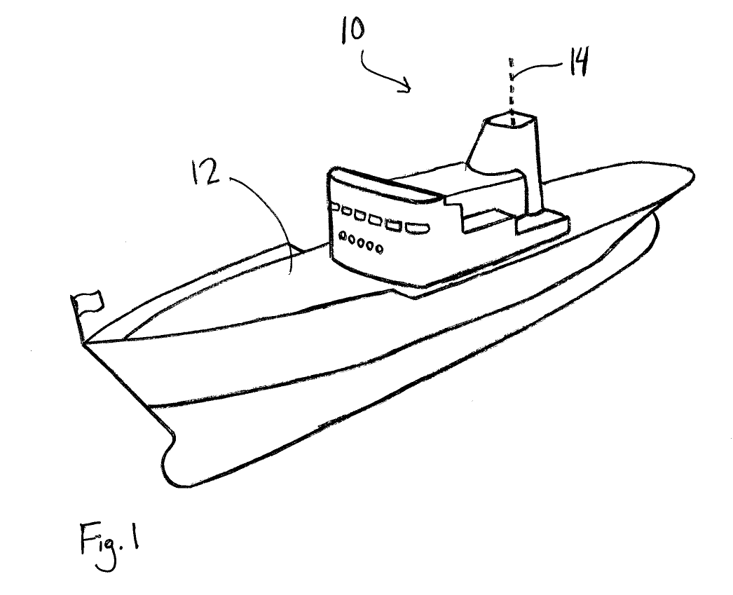

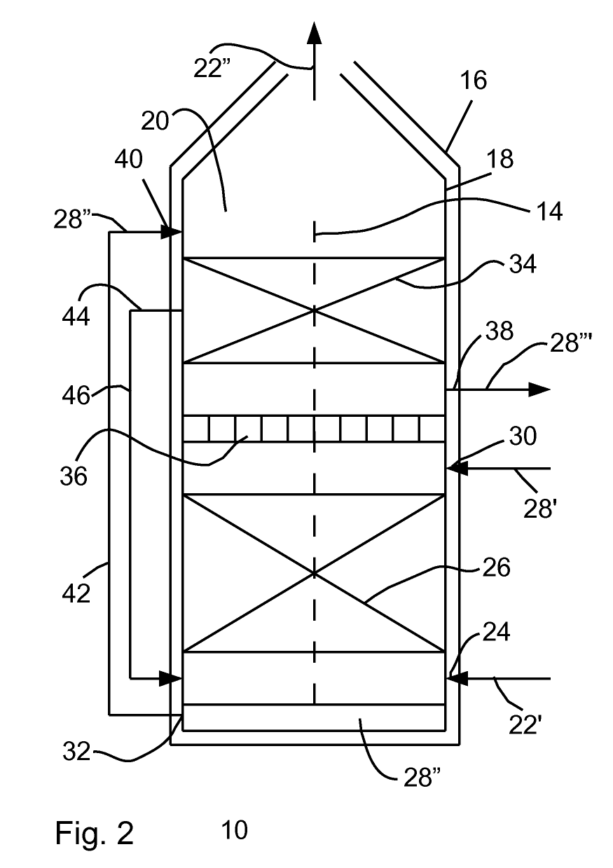

Referring initially to FIG. 1, a vessel apparatus is shown and generally designated 10. As shown, the vessel apparatus 10 is formed and defined by a ship 12. Further, the shipboard vessel apparatus 10 defines a vertical axis 14. Referring now to FIG. 2, it can be seen that the vessel apparatus 10 includes a vessel 16 having a wall 18 that bounds a chamber 20 which extends along the axis 14.

As illustrated in FIG. 2, the vessel apparatus 10 is intended to scrub pollutants from exhaust gases 22′ that are produced during the combustion of diesel ship fuel and that have a sulfur content of about 2.9 or 3%. Therefore, the apparatus 10 provides for an exhaust port 24 formed at the bottom end of the vessel 16 to introduce the exhaust gases 22′ into the chamber 20. Also, a scrubber 26 is located within the chamber 20 and may be designed for optimal removal of sulfur dioxide from the exhaust gases 22′ in certain embodiments. For this purpose, the scrubber 26 utilizes seawater 28′ as a solvent to remove sulfur dioxide from the exhaust gases 22′. In order to allow for the use of solvent seawater 28′, a seawater inlet 30 may be formed in the vessel above the scrubber 26 to feed the seawater 28′ into the scrubber 26. Also, an effluent outlet 32 may be formed in the vessel below the scrubber to remove the effluent seawater 28″ downstream from the scrubbing process.

In order to treat the effluent seawater 28″, the vessel apparatus 10 provides for a processing component 34 that is positioned within the vessel 16. Specifically, the processing component 34 is positioned within the vessel 16 above the scrubber 26. Depending on the desired operation of the apparatus 10, the processing component may be a degasifier, an oxidizer, a caustic addition stage, or a separator. Also, a liquid barrier 36 is mounted within the vessel 16 between the scrubber 26 and the processing component 34 to allow the exhaust gases 22′ to exit the top of the vessel 16 while prohibiting flow of the effluent seawater 28″ into the top of the scrubber 26. As shown, a discharge port 38 is formed in the vessel 16 to allow the treated effluent seawater 28′″ to exit the vessel 16 for further treatment or for discharge into the sea.

In order to deliver the effluent seawater 28″ to the processing component 34, the apparatus 10 includes a recirculation port 40. As shown, the recirculation port 40 is connected to the effluent outlet 32 by a recirculation conduit 42. As a result, the effluent seawater 32 can be delivered from below the scrubber 26 to above the processing component 34 for treatment.

In certain embodiments, the processing component 34 is a degasifier 34a. Due to reactions during the scrubbing process, the effluent seawater 32 may contain dissolved carbon dioxide. To raise the pH of the effluent seawater 32, the degasifier 34a provides for the removal of the carbon dioxide and other gases, including unscrubbed sulfur dioxide, from the effluent seawater 32. If a degasifier 34a is used as the process component 12, the apparatus 10 may further include a conduit 44 for delivering gases 46 removed from the effluent seawater 28″ back into the bottom of the chamber 20 for further scrubbing by the scrubber 26. Alternatively, the processing component 34 may be an oxidizer 34b for reducing the chemical oxygen demand of the effluent seawater. Also, the processing component 34 may be a separator 34c, such as a hydroclone centrifugal separator, for removing particulate and oils from the effluent seawater 28″. Further, the processing component 34 may be a caustic addition stage 34d. For such a stage 34d, caustic chemicals are introduced to neutralize the acidic effluent seawater 28″ after the scrubbing process.

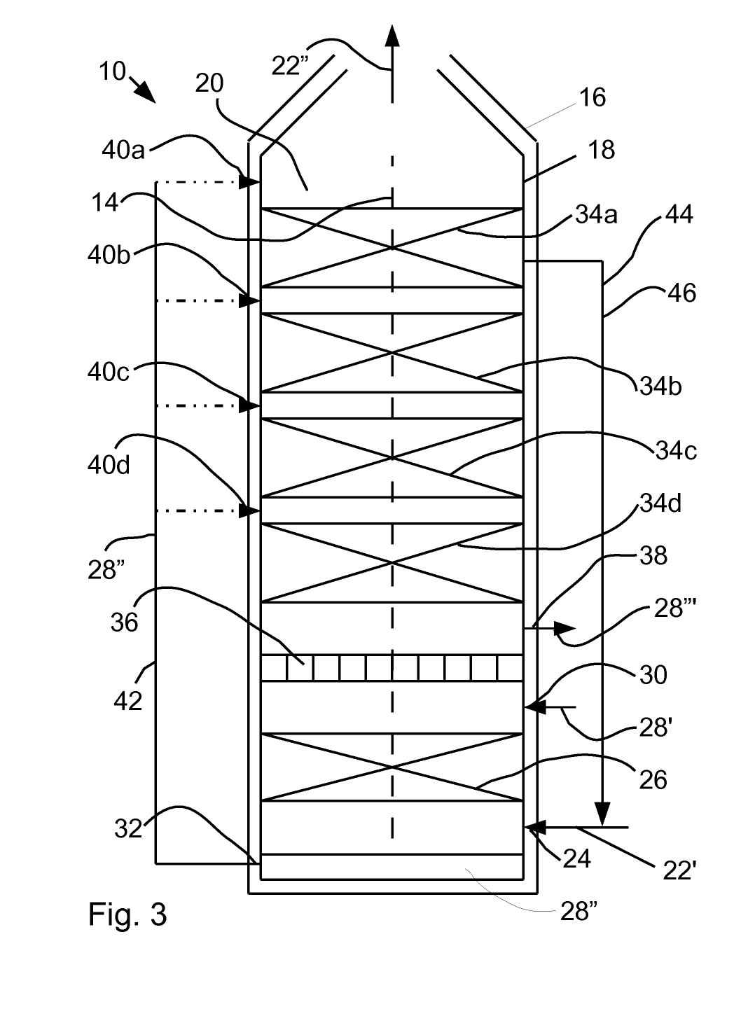

Referring to FIG. 3, an alternative vessel apparatus 10 is shown. In FIG. 3, a plurality of processing components 34 are positioned vertically in series above the liquid barrier 36. As shown, the degasifier 34a receives and treats the effluent seawater 28″ first. Thereafter, the oxidizer 34b receives and treats the effluent seawater 28″. Then, the separator 34c removes particulate and oils from the effluent seawater 28′″. Finally, the caustic addition stage 34d neutralizes the effluent seawater 28″ before the treated effluent seawater 28′″ exits the vessel 16. While FIG. 3 illustrates the use of four processing components 34, it is noted that any one, two or three processing components 34 may be utilized. Further, as shown in FIG. 3, a plurality of recirculation ports 40a, 40b, 40c may be used to deliver the effluent seawater 28″ as desired.

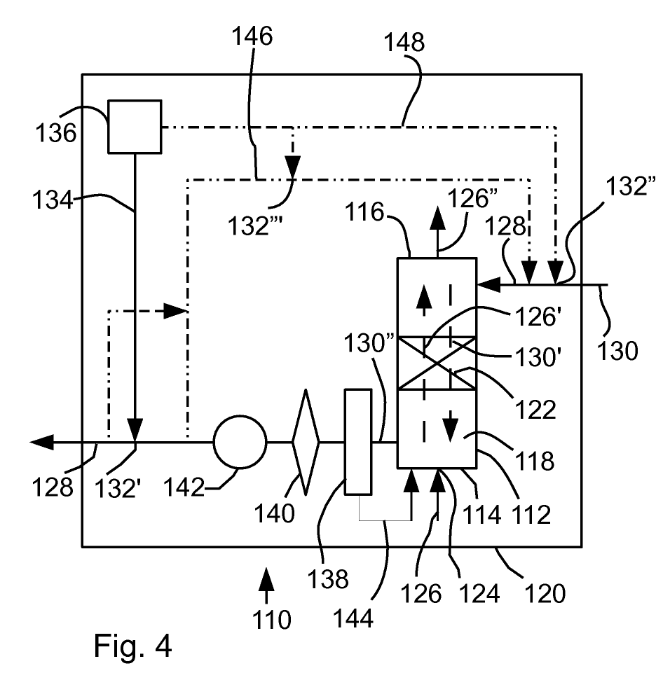

Referring now to FIG. 4, a scrubbing system for removing sulfur dioxide from shipboard diesel exhaust gases is shown and generally designated 110. While the layout of the system 110 disclosed in FIG. 4 is different from the vessel apparatus 10 of FIGS. 1-3, the operational components illustrated and discussed shed light on the operation of the vessel apparatus 10. As shown in FIG. 4, the system 110 comprises a single-stage countercurrent scrubber 112 having a bottom end 114 and a top end 116 and defining a chamber 118. As shown, the scrubber 112 is mounted on a ship 120.

Within the chamber 118 of the scrubber 112, is a countercurrent vapor-liquid contact mechanism 122. For the system 110, the mechanism 122 may be tray-type, packed bed, direct spray or other arrangement for providing countercurrent vapor-liquid contact. As shown, the scrubber 112 is provided with an inlet 124 at its bottom end 114 for introducing exhaust gases 126 including sulfur dioxide into the chamber 118. For ships, combustion of the standard diesel fuel results in exhaust gases 26 containing about 2.9 or 3.0% sulfur.

At its top end 116, the scrubber 112 is in fluid communication with a conduit 128 for feeding seawater 130 into the chamber 118. As is typical for vapor-liquid contact scrubbers, the liquid seawater 130′ falls from the top end 116 to the bottom end 114 while contacting the exhaust gases 126′ rising through the chamber 118. During this contact, the seawater 130′ absorbs the sulfur dioxide from the exhaust gases 126, and fully scrubbed exhaust gases 126″ are released by the scrubber 112. In certain embodiments, 97% of the sulfur dioxide is removed from the exhaust gases 126″, as opposed to the single pass norm of about 70% for contemporary shipboard systems.

As further shown in FIG. 4, the conduit 128 is in fluid communication with the bottom end 114 of the scrubber 112 to remove the effluent seawater 130″. For purposes of the present invention, the conduit 128 is also in fluid communication with a port 132′ for adding caustic 134 from a caustic tank 136 to neutralize the acidic effluent seawater 130. Preferably, the caustic 134 is sodium hydroxide, potassium hydroxide, sodium carbonate, calcium carbonate, calcium hydroxide, ammonium hydroxide or a similar material. After the effluent seawater 130″ has reached an acceptable pH level, it is discharged from the ship 120.

While the described system 110 operates sufficiently to enable the shipboard use of a seawater scrubber 112, it may further include a degasifier 138, an oxidizer 140, and a separator 142 in fluid communication with the conduit 128. As a result of processing, the effluent seawater 130″ may contain dissolved carbon dioxide, which is acidic. In order to reduce the amount of caustic 134 required for effective treatment of the effluent seawater 130″, the degasifier 138 removes dissolved carbon dioxide from the effluent seawater 130″ and facilitates the caustic-addition neutralization process. Further, the degasifier 138 may also remove some sulfur dioxide from the effluent seawater 130″, therefore, the system 110 provides for feeding the removed gas back into the bottom end 114 of the scrubber 112 through a conduit 144.

For the system 110, the oxidizer 140 is used to reduce the chemical oxygen demand of the seawater 130″. Specifically, the effluent seawater 130″ includes sulfur trioxide, which is a partially oxidized form of sulfur. In order to convert the sulfur trioxide (SO₃) to the fully oxidized sulfur oxide (SO₄), an oxygen is required, and is provided by the oxidizer 140. As a result, the chemical oxygen demand of the effluent seawater 130″ is reduced. For the system 110, the oxidizer 140 may be a physical oxidizer like a permanganate bed or a liquid oxidizer like peroxide, ozone or others. For liquid oxidizers, the oxygen demand is decreased while no additional salinity is added to the effluent seawater 130″.

In certain embodiments, the separator 142 is a hydroclone centrifugal separator which first removes particulate, such as ash, from the effluent seawater 130″. Later, in the same process, the separator 142 removes oils from the effluent seawater 130″. As a result, the effluent seawater 130″ is more safely prepared for discharge into the sea.

During operation of the system 110, the seawater 130 fed into the scrubber 112 will typically have an alkalinity in the range of about 900 to about 2400 micromoles per liter with a pH of about 5.0 or above. In certain embodiments, the seawater 130 at the top end 116 of the scrubber 112 must be at a pH of higher than the theoretical removal efficiency for the sulfur dioxide in the exhaust gases. If the pH is too low, the last of the sulfur dioxide will not absorb into it. Of course, with fresh seawater 130 entering the scrubber 112, the pH is generally sufficiently high. As the seawater 130′ absorbs the sulfur dioxide from the exhaust gases 126′, it will convert the sulfur dioxide into sulfite and sulfur trioxide. This absorption and conversion process is driven principally by water loading, gas loading, temperature and pH. While seawater is an abundant, low cost source of alkalinity and an absorbent solvent, its use is limited by the regulated pH of the seawater discharged back into the sea. In the past, academic and commercial sources have operated seawater scrubbers at a pH of 6.0-7.0, typically at 6.5. For the present invention, the effluent seawater 130″ exiting the scrubber 112 will have a pH of less than 4.5, less than 3.5, less than 3.0, or about 2.5 or 2.0. However, the discharge pH may be required to be about 6.5.

As explained above, in order to obtain an acceptable discharge pH, the system 110 provides for the addition of caustic 134 to the effluent seawater 130″. As a result, the added caustic 134 can make up for the load of the sulfur dioxide and the quantity of seawater 130 required to remove the sulfur dioxide while still meeting the discharge pH requirements.

While one embodiment of the system 110 has been described above, FIG. 4 discloses several other embodiments. Specifically, as described above, the seawater 130 makes a single pass through the scrubber 112. However, the seawater 130 may be partially recirculated if desired. As shown, a recirculation path 142 allows some of the effluent seawater 130″ to be recycled to be fed into the scrubber 112 by the conduit 128.

Further, as described above, the caustic 134 is added to the seawater 130 at a port 132′ downstream of the scrubber 112. Alternatively or additionally, the caustic 134 may be added to the seawater 130 at a port 132″ upstream of the scrubber 112, and/or to the recirculation path 142 at a port 132′″. While a single tank 136 is illustrated, the system 110 may include a plurality of tanks 136 for providing caustic at different ports 132.

While the particular Shipboard Vessel Having a Vertically Aligned Scrubber and Process Component as herein shown and disclosed in detail is fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A vessel apparatus for scrubbing exhaust gases from a ship comprising:
a vertically oriented vessel;
a scrubber positioned within the vessel;
a degasifier positioned within the vessel above the scrubber;
a liquid barrier positioned within the vessel between the scrubber and the degasifier;
an exhaust port formed in the vessel below the scrubber for introducing the exhaust gases into the scrubber;
a seawater inlet formed in the vessel between the liquid barrier and the scrubber for feeding seawater into the scrubber to scrub the exhaust gases;
a recirculation conduit passing through the vessel at an effluent outlet positioned below the scrubber and at a recirculation port positioned above the degasifier to flow the effluent seawater into the degasifier to raise the pH of the effluent seawater; and
a discharge port formed in the vessel between the degasifier and the liquid barrier for discharging degasified effluent seawater from the vessel.

2. The vessel apparatus as recited in claim 1 wherein the seawater absorbs sulfur dioxide from the exhaust gases, and wherein the degasifier removes dissolved carbon dioxide from the effluent seawater.

3. The vessel apparatus as recited in claim 1 further comprising a caustic addition stage wherein caustic is added to the effluent seawater to raise the pH of the effluent seawater.

4. The vessel apparatus as recited in claim 3 wherein the caustic is selected from the group consisting of sodium hydroxide, potassium hydroxide, sodium carbonate, calcium carbonate, calcium hydroxide, and ammonium hydroxide.

5. The vessel apparatus as recited in claim 3 wherein the caustic addition stage is positioned in the vessel above the liquid barrier.

6. The vessel apparatus as recited in claim 1 further comprising an oxidizer positioned in the vessel above the liquid barrier to reduce a chemical oxygen demand of the effluent seawater.

7. The vessel apparatus as recited in claim 1 the seawater has an alkalinity in the range of about 900 to about 2400 micromoles per liter.

8. The vessel apparatus as recited in claim 7 wherein the seawater is discharged into the sea with a pH of about 6.5.

9. A vessel apparatus for scrubbing exhaust gases from a ship comprising:
a vertically oriented vessel;
a scrubber positioned within the vessel;
at least one processing component positioned within the vessel above the scrubber, said processing component being selected from the group consisting of a degasifier, an oxidizer, and a caustic addition stage;
a liquid barrier positioned within the vessel between the scrubber and the selected processing component;
an exhaust port formed in the vessel below the scrubber for introducing the exhaust gases into the scrubber;
a seawater inlet formed in the vessel between the liquid barrier and the scrubber for feeding seawater into the scrubber to scrub the exhaust gases;
a recirculation conduit passing through the vessel at an effluent outlet positioned below the scrubber and at a recirculation port positioned above the selected component to flow the effluent seawater into the selected processing component for treatment of the effluent seawater; and
a discharge port formed in the vessel between the selected component and the liquid barrier for discharging treated effluent seawater from the vessel.

10. The vessel apparatus as recited in claim 9 wherein two processing components are selected from the group consisting of a degasifier, an oxidizer, and a caustic addition stage, and wherein each selected processing component is positioned within the vessel above the scrubber.

11. The vessel apparatus as recited in claim 10 wherein three processing components are selected from the group consisting of a degasifier, an oxidizer, and a caustic addition stage, and wherein each selected processing component is positioned within the vessel above the scrubber.

12. The vessel apparatus as recited in claim 9 wherein the exhaust gases include sulfur dioxide and wherein the seawater absorbs the sulfur dioxide from the exhaust gases in the scrubber.

13. The vessel apparatus as recited in claim 12 wherein the caustic addition stage is selected and wherein, at the caustic addition stage, caustic is added to the effluent seawater to raise the pH of the effluent seawater.

14. The vessel apparatus as recited in claim 12 wherein the degasifier is selected, and wherein the degasifier removes carbon dioxide from the effluent seawater to raise the pH of the effluent seawater.

15. The vessel apparatus as recited in claim 12 wherein the oxidizer is selected and wherein the oxidizer reduces the chemical oxygen demand of the effluent seawater.

16. A vessel apparatus for scrubbing exhaust gases from a ship comprising:
a vertically oriented vessel;
a scrubber positioned within the vessel for absorbing pollutants from the exhaust gases into seawater;
a means for treating effluent seawater, said treating means being located within the vessel above the scrubber;
a liquid barrier positioned within the vessel between the scrubber and the treating means;
an exhaust port formed in the vessel below the scrubber for introducing the exhaust gases into the scrubber;
a seawater inlet formed in the vessel between the liquid barrier and the scrubber for feeding the seawater into the scrubber to scrub the exhaust gases;
a recirculation conduit passing through the vessel at an effluent outlet positioned below the scrubber and at a recirculation port positioned above the treating means; and
a discharge port formed in the vessel for discharging treated effluent seawater from the vessel.

17. The vessel apparatus as recited in claim 16 wherein the exhaust gases include sulfur dioxide and wherein the seawater absorbs the sulfur dioxide from the exhaust gases in the scrubber.

18. The vessel apparatus as recited in claim 18 wherein the scrubber is a first stage and wherein the treating means is a second stage.

19. The vessel apparatus as recited in claim 18 wherein the treating means is a degasifier.

20. The vessel apparatus as recited in claim 19 wherein the degasifier removes dissolved carbon dioxide from the effluent seawater.
